(19) United States
(12) Patent Application Publication
(10) Pub. No.: US 2015/0122798 A1
(43) Pub. Date: May 7, 2015

(54) Heating Device

(71) Applicant: SANDEN CORPORATION, Isesaki-shi (JP)

(72) Inventor: Yoshinobu Maemura, Isesaki-shi (JP)

(21) Appl. No.: 14/400,327

(22) PCT Filed: May 8, 2013
(86) PCT No.: PCT/JP2013/062920

§ 371 Date: Nov. 10, 2014

(30) Foreign Application Priority Data
May 10, 2012 (JP) 2012-108323

(51) Int. Cl. H05B 1/02

(52) U.S. Cl. CPC H05B 1/0202; H05B 1/0236
USPC 219/510

(57) ABSTRACT

A heating device includes a heater (2) having a heating portion (6) which generates heat by energization; a housing (4) which contains the heating portion and forms a passage (18) for a heating medium between the housing and the heating portion; a temperature detection means (26) for detecting the temperature of the heating medium in the passage; and an energization interrupting means for interrupting the carrying of current to the heater depending on the temperature of the heating medium detected by the temperature detection means. The temperature detection means is brought into contact with the heating portion.

### TECHNICAL FIELD

The present invention relates to heating devices, and particularly to a heating device including a housing which forms a passage for a heating medium between the housing and a heating portion of a heater.

### BACKGROUND ART

It is known that a heating device of this kind includes a heater having a heating portion which generates heat by energization; a housing which contains the heating portion and forms a passage for a heating medium between the housing and the heating portion; a temperature detection means for detecting the temperature of the heating medium in the passage; and an energization interrupting means for interrupting the carrying of current to the heater depending on the detected temperature of the heating medium.

Patent Document 1 discloses a heating device which is provided with a thermostat or a thermal fuse at the outside of the housing, on a surface shared with the heating face of the heating portion. Thus, the heating device prevents accidental heating of the passage with no heating medium while preventing a malfunction in the thermal fuse.

Patent Document 2 discloses a heating device which is provided with a thermal fuse at the current-carrying terminal. Heat transferred from the heating portion via the current-carrying terminal causes the heating device to interrupt the carrying of current to the heater regardless of the level of the heating medium in the passage so as to prevent accidental heating of an empty passage.

Patent Document 3 discloses a heating device which is provided with a convex on the inside of the housing. The heating device prevents accidental heating of the passage with no heating medium by placing a thermal fuse into contact with the heating portion via the convex of the housing.

### PRIOR ART DOCUMENT

### Patent Document

Patent Document 1: Japanese Patent No. 4561319

Patent Document 2: Japanese Patent No. 4293091

Patent Document 3: Japanese Patent No. 3395571

### SUMMARY OF THE INVENTION

### Problems to be Solved by the Invention

Unfortunately, a heating device according to each of the Patent Documents 1 to 3 is unable to stop the heater swiftly due to a deterioration in the responsiveness of the energization interrupting means because the heating device has its temperature detection means placed into contact with a non-heating portion of the heater located outside the housing, and the carrying of current to the heater is interrupted based on heat transferred via the non-heating portion. For that reason, the accuracy of detection of accidental heating of an empty passage can be decreased, leading to an occurrence of smoke or fire.

The present invention has been made based on the above-mentioned circumstances, and an object of the present invention is to provide a heating device capable of detecting accidental heating of an empty passage with high accuracy by detecting the temperature of the heating medium, interrupting energization with excellent responsiveness, and securely preventing an occurrence of smoke or fire so as to improve reliability of the heating device.

### Means for Solving the Problems

In order to achieve the above object, a heating device of the present invention includes a heater having a heating portion which generates heat by energization; a housing which contains the heating portion and forms a passage for a heating medium between the housing and the heating portion; a temperature detection means for detecting the temperature of the heating medium in the passage; and an energization interrupting means for interrupting the carrying of current to the heater depending on the temperature of the heating medium detected by the temperature detection means. The temperature detection means is brought into contact with the heating portion.

Preferably, the temperature detection means should come into surface contact with the heating portion.

Preferably, the temperature detection means should be connected to the housing via a seal member.

Preferably, a plurality of the seal members should be provided.

### Advantageous Effects of the Invention

According to the present invention, a heating device with high reliability can be provided owing to the following reasons. The heating device includes a temperature detection means for detecting the temperature of a heating medium in a passage for the heating medium, and an energization interrupting means for interrupting the carrying of current to a heater depending on the temperature of the heating medium detected by the temperature detection means. The heating device is capable of detecting accidental heating of an empty passage with high accuracy by detecting the temperature of the heating medium, interrupting energization with excellent responsiveness and securely preventing an occurrence of smoke or fire because the temperature detection means is brought into contact with a heating portion of the heater.

### BRIEF DESCRIPTION OF THE DRAWINGS

FIG. 1 is a longitudinal sectional view of a heating device in accordance with an embodiment of the present invention.

FIG. 2 is a cross-sectional view illustrating a principal part of the heating device taken from line A-A in FIG. 1.

FIG. 3 is a cross-sectional view illustrating a principal part of a heating device in accordance with a variation of the present invention, taken from line A-A in FIG. 1.

FIG. 4 is a cross-sectional view illustrating a principal part of a heating device in accordance with another variation of the present invention, taken from line A-A in FIG. 1.

### MODE FOR CARRYING OUT THE INVENTION

A heating device in accordance with an embodiment of the present invention will now be described with reference to the attached drawings.

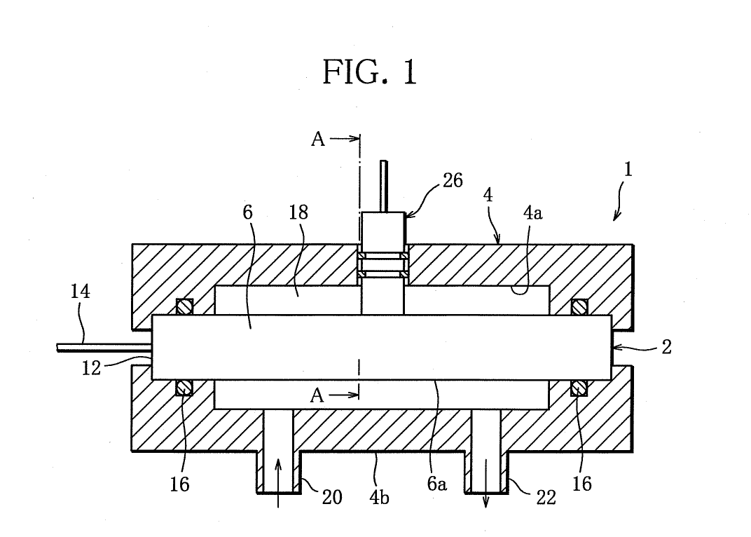

As shown schematically in FIG. 1, a heating device 1 includes a heater 2 and a case (housing) 4 which contains the heater 2.

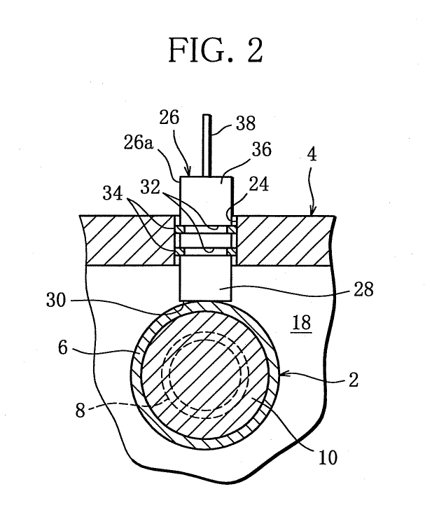

As shown schematically in FIG. 2, the heater 2 is an electrothermal heater which generates heat by energization. The heater 2 is composed of a bottomed cylindrical metal pipe 6 (heating portion). A coiled heating wire 8 such as a nichrome wire is inserted in the metal pipe 6, and a heat-resistant insulating material 10, such as magnesium oxide, having high electrical insulation properties and thermal conductivity is filled into the metal pipe 6 by pressure to seal the heating wire 8.

A terminal 12 molded from silicon, glass and the like by casting is provided at one end opening of the metal pipe 6. A lead wire 14 connected to the heating wire 8 is pulled through the terminal 12. The lead wire 14 and an external power unit (not shown) electrically connected to the lead wire 14 constitute an energization circuit (not shown) for providing the heating wire 8 with electricity. Although only one heater 2 is shown in FIG. 1, two or more heaters 2 may be provided.

The case 4 is composed of one or more cast bodies. The case 4 contains the heater 2 by airtightly surrounding vicinities of both ends of the metal pipe 6 through O-rings 16. Clearance is created between an inner surface 4a of the case 4 and an outer circumference 6a of the metal pipe 6. The clearance serves as a passage 18 into which a heating medium as a LLC (coolant, antifreeze), such as ethylene glycol, flows. An inlet pipe 20 and an outlet pipe 22 for the heating medium are protrusively provided at appropriate positions on an outer surface 4b of the case 4 so that the both pipes communicate with the passage.

The heating device 1 having such a schematic configuration, which is to be mounted, for example, in a hybrid car, an electric vehicle and the like, is used to heat a coolant or the like circulating through a refrigeration circuit in an air conditioning apparatus for a vehicle, serving as an auxiliary heat source for providing heat to make up a shortage in waste heat out of the engine in the case of a hybrid car, or as an alternative heat source for providing heat in place of the engine that does not exist in the case of an electric vehicle.

For example, in the case of a hybrid car, an LLC circulating in a cooling water circuit (not shown) for cooling an engine flows via the inlet pipe 20 into the passage 18, and the heater 2 heats the LLC. Heat from the LLC which has been heated by the engine and the heating device 1 is used to heat a coolant circulating through a refrigeration circuit provided in an air conditioning apparatus for the vehicle. The heated coolant is used to heat and cool the air in the vehicle cabin. The LLC which has been used for heating the coolant is discharged from the passage 18 via the outlet pipe 22 and returned to the cooling water circuit. Then, the LLC is again used to cool the engine.

According to the present embodiment, a through-hole 24 is bored into the case 4 in a direction perpendicular to the longitudinal direction of the heater 2. A temperature sensor 26 (temperature detection means) for detecting the temperature of a LLC which flows through the passage 18 is inserted in the through-hole 24. The temperature sensor 26 is a roughly cylindrical shaped thermistor. A flat end face 30 of a temperature measurement end 28 of the temperature sensor 26 comes into line contact with the outer circumference 6a of the metal pipe 6 of the heater 2. This enables the temperature sensor 26 to detect not only the temperature of the LLC but also the surface temperature of the metal pipe 6, i.e. the heating portion of the heater 2.

Two annular grooves 32 are formed on a side 26a of the temperature sensor 26. An O-ring 34 (seal member) is fitted to each annular groove 32. The temperature sensor 26 is airtightly connected to and secured to the through-hole 24 through each O-ring 34.

The temperature sensor 26 is electrically connected to an inverter (not shown) through a lead wire 38 pulled out of its outer end 36. The inverter controls energization (energization interrupting means) by turning on and off the carrying of current to the heater 2 in response to the temperature of the LLC and/or the surface temperature of the metal pipe 6 detected with the temperature sensor 26 through the power unit and the energization circuit described above.

When an LLC exists in the passage 18, the temperature of the LLC is controlled within a proper range by the use of the temperature sensor 26 under this energization control. Thus, the temperature of the heater 2 does not abnormally rise.

On the other hand, conventionally, when no or little LLC exists in the passage 18 due to absence of the LLC supply to the cooling water circuit, a leakage of the LLC from the cooling water circuit or other reasons, there is no or little heating medium for transferring heat from the heater 2. If this happens, the heating device 1 can undergo accidental heating of an empty passage, leading to a trouble that the temperature of the heater 2 itself abnormally rises. Even when such accidental heating of an empty passage occurs, the heating device 1 having the temperature sensor 26, which is out of contact with the metal pipe 6 and capable of detecting only the temperature of the LLC in the case of a conventional heating device, can undergo a deterioration in the responsiveness of the temperature sensor 26 due to the heat-insulation effect of the air surrounding the temperature sensor 26, leading to a delay in the detection of such accidental heating. As a result, temperature in the passage 18 can go on to increase, causing an occurrence of smoke or fire in the heating device 1.

In contrast, the present embodiment provides energization control by taking advantage of a difference in heat transfer property between the LLC as a fluid and the air as a gas, that is, the temperature of the LLC becomes dominant when the LLC exists in the passage 18 and the temperature of the heater 2 becomes dominant when no or little LLC exists in the passage 18, as the temperature sensor 26 is brought into direct contact with the outer circumference 6a of the metal pipe 6, i.e. the heating portion of the heater 2, while the temperature sensor 26 is placed in the passage 18 where the LLC flows.

The present embodiment as described above provides normal energization control without stopping the heating device 1 for protection when an LLC exists in the passage 18 while the present embodiment provides error processing to stop promptly the heating device 1 for protection when no or little LLC exists in the passage 18. Thus, it is possible to provide the heating device 1 that achieves high reliability as it promptly detects accidental heating of an empty passage with high accuracy and prevents reliably an occurrence of smoke or fire while performing normal energization control by the use of the temperature sensor 26.

Since each O-ring 34 is fitted to each of the annular grooves 32 formed on the side 26a of the temperature sensor 26, the temperature sensor 26 is airtightly connected to and secured to the through-hole 24 through each of the O-rings 34. So-called dual seals provide the prevention of leakage of the LLC from the case 4. This prevents an occurrence of accidental heating of an empty passage caused by a decrease in the amount of the LLC in the passage 18, leading to the heating device 1 of higher reliability. Even if only one O-ring 34 is fitted to the temperature sensor 26, leakage of the LLC from the case 4 can be prevented.

The present invention is not limited to the embodiment of the heating device 1 described above, but various alterations may occur.

For example, as the end face 30 of the temperature measurement end 28 of the temperature sensor 26 is flat in the above-mentioned embodiment, the temperature measurement end 28 comes into line contact with the outer circumference 6a of the metal pipe 6. It is, however, preferable that the area of contact between the temperature sensor 26 and the metal pipe 6 be larger so as to make larger the heat transfer area between the temperature sensor 26 and the metal pipe 6.

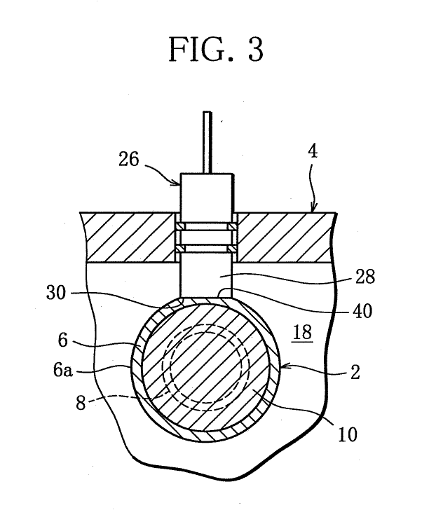

Specifically, with reference to FIG. 3, a flat surface 40 is formed on a part of the outer circumference 6a of the metal pipe 6, and the end face 30 of the temperature measurement end 28 is brought into contact with the flat surface 40. Since the temperature sensor 26 is placed into surface contact with the metal pipe 6, the heat transfer area between the temperature sensor 26 and the metal pipe 6 gets larger. This brings about a further improvement in the responsiveness of the energization interrupting means and provides the detection of accidental heating of an empty passage with higher accuracy.

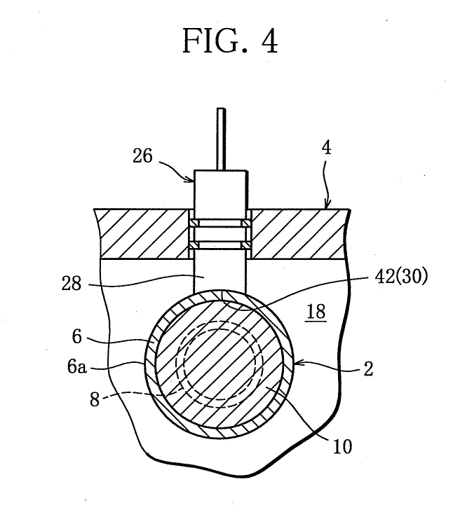

Alternatively, with reference to FIG. 4, a concave curved surface 42 having a radius almost equal to the curvature radius of the outer circumference 6a of the metal pipe 6 may be formed on the end face 30 of the temperature measurement end 28 of the temperature sensor 26, and the outer circumference 6a of the metal pipe 6 may be brought into contact with the concave curved surface 42 so that the temperature sensor 26 is placed into surface contact with the metal pipe 6.

In the embodiment described above, one O-ring 34 is fitted to each of the two annular grooves 32 on the side 26a of the temperature sensor 26. Thus, two O-rings 34 are provided. The number of the O-rings 34, however, is not limited to this example. Nevertheless, providing at least two O-rings 34 produces not only the effect of the dual seals described above but also an aligning effect in keeping the temperature sensor 26 from being out of alignment with respect to the through-hole 24. Consequently, the responsiveness of the energization interrupting means and the accuracy in the detection of accidental heating of an empty passage can be reliably increased.

Although the temperature sensor 26 acts as a temperature detection means and the inverter for controlling energization acts as an energization interrupting means in the embodiment described above, a thermal fuse or the like incorporating both the temperature detection means and the energization interrupting means may be brought into contact with the metal pipe 6.

The heating device 1 according to the present invention is not limited to use in a car air conditioning apparatus of a hybrid car or an electric vehicle, but can be used as a heat source for other purposes.

### Explanation of Reference Signs

1 heating device

2 heater

4 case (housing)

6 metal pipe (heating portion)

18 passage

26 temperature sensor (temperature detection means)

34 O-ring (seal member)

1. A heating device comprising:
a heater having a heating portion which generates heat by energization;
a housing which contains the heating portion and forms a passage for a heating medium between the housing and the heating portion;
a temperature detection means for detecting the temperature of the heating medium in the passage; and
an energization interrupting means for interrupting the carrying of current to the heater depending on the temperature of the heating medium detected by the temperature detection means,
wherein the temperature detection means is brought into contact with the heating portion.

2. The heating device according to claim 1, wherein the temperature detection means comes into surface contact with the heating portion.

3. The heating device according to claim 1, wherein the temperature detection means is connected to the housing via a seal member.

4. The heating device according to claim 3, wherein a plurality of the seal members are provided.

5. The heating device according to claim 2, wherein the temperature detection means is connected to the housing via a seal member.

6. The heating device according to claim 5, wherein a plurality of the seal members are provided.
